(19) United States
(12) Patent Application Publication
(10) Pub. No.: US 2008/0280024 A1
(43) Pub. Date: Nov. 13, 2008

(54) Lentil Extract

(76) Inventors: Douglas Harle, Regina (CA); Rick Green, Saskatoon (CA)

Correspondence Address: ADE & COMPANY INC., 2157 Henderson Highway, WINNIPEG, MB, R2G1P9, CA

(21) Appl. No.: 11/694,319

(22) Filed: Mar. 30, 2007

Related U.S. Application Data
(60) Provisional application No. 60/787,152, filed on Mar. 30, 2006.

(51) Int. Cl. A23J 1/14

(52) U.S. Cl. 426/656

(57) ABSTRACT

A precipitated protein fraction, a high protein retentate and a high starch solid fraction are derived from lentils.

### PRIOR APPLICATION INFORMATION

This application claims the benefit of US Provisional patent application 60/787,152, filed Mar. 30, 2006.

### BACKGROUND OF THE INVENTION

Dehulling/processing of lentils leaves a by-product which consists of a mixture of hulls, starch and protein. Currently, the by-product is sold for animal feed.

However, the screenings contain approximately 21% protein, 20% starch and 59% fiber. Further concentration of the protein and starch fractions for food and other non-food applications can increase the value of the by-product.

### SUMMARY OF THE INVENTION

According to a first aspect of the invention, there is provided a method comprising:

providing a quantity of byproduct fraction from lentil dehulling, said byproduct fraction comprising hulls, fiber, starch protein and vitamins and other nutrients;

removing the hulls from the byproduct fraction, thereby producing a protein enriched fraction;

solubilizing the protein in the protein enriched fraction by subjecting the protein enriched fraction to an aqueous alkaline extraction;

removing solids from the protein enriched fraction, thereby providing a solids fraction having a high starch content and a solubilized protein enriched fraction;

precipitating the protein from the solubilized protein enriched fraction by acidifying the solubilized protein enriched fraction, thereby producing precipitated protein and a retentate; and

recovering the precipitated protein.

The alkaline extraction may be at a pH of 8.5 to 9.5.

The solubilized protein enriched fraction may be acidified to a pH between 4.5 and 6.5. Under the specified processing conditions vitamins and other nutrients from the lentil byproduct are retained in the protein fraction.

### BRIEF DESCRIPTION OF THE DRAWINGS

FIG. 1. Schematic diagram of the lentil by-product processing method.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein are a process and a method for fractionation and isolation of protein, starch and fiber from a quantity of lentils. In preferred embodiments, the lentil is a red lentil. In other embodiments, the lentils are whole lentils, dehulled lentils or a lentil milling by-product, as discussed below.

As will be known to one of skill in the art, there are two basic types of lentil, both of which are grown worldwide: Chilean (a large seeded type) and Persian (a smaller seeded type). Specific varieties include but are by no means limited to Laird, Eston, CDC Richlea, CDC Gold, CDC Royale, CDC Matador, CDC Milestone, CDC Vintage and CDC Glamis. In other embodiments, the lentil is a red lentil, for example, but by no means limited to, 12545-1, CDC-blaze, CDC-Redcap, CDC-Robin and CDC-Redwing.

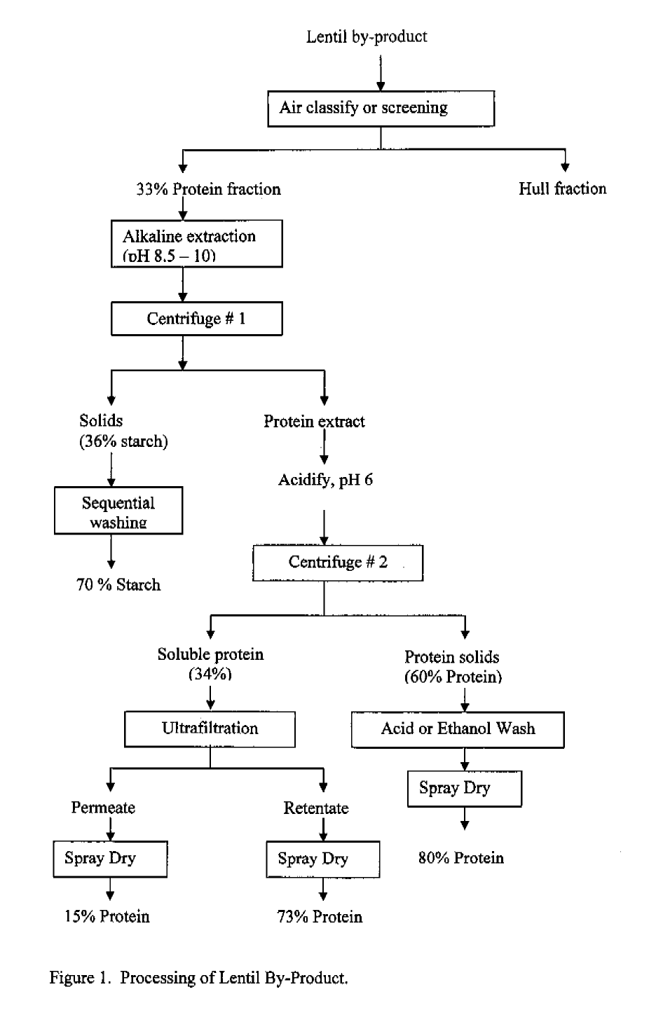

Referring to FIG. 1, in one embodiment of the invention, lentils are dehulled and the by-product comprising hulls, starch, protein and fiber is recovered for further processing. Typically, this by-product portion comprises approximately 15-25% protein and 15-25% starch.

In some embodiments, the by-product is separated, for example, by separating the by-product by size, including but by no means limited to screening through a 70 mesh screen or by classifying on an air classifier, thereby separating the hulls from the hull-reduced lentil fraction. This fraction has a 25-45% protein content.

In other embodiments, whole lentils are subjected to the extraction steps as described above. As will be appreciated by one of skill in the art, in these embodiments, the lentils may be subjected to physical or chemical means which facilitate subsequent solubilization of protein, for example, grinding or otherwise reducing the size of the whole lentils to facilitate extraction of protein therefrom. Specifically, whole lentils may be ground or otherwise fractured and the hulls may be separated therefrom as discussed above.

In other embodiments, dehulled lentils are used. In these embodiments, the initial screen to remove the hulls is not needed as the hulls have already been removed by means known in the art.

As such, the initial step of the process can be defined as preparing a quantity of lentils for protein extraction. The quantity of lentils may be whole lentils, dehulled lentils, the dehulling byproduct or combinations thereof. In instances where hulls are present, for example, where whole lentils and/or dehulling byproduct are present, the hulls are removed by a screening process as discussed above. This produces a ‘hull-reduced’ lentil fraction, although it is to be understood that this indicates that the lentil fraction is substantially hull-free or that the quantity of hull particles in the fraction has been reduced by screening as discussed above but does not necessarily mean that all hull particles have been removed.

The hull-reduced lentil fraction is then further processed by solubilizing the protein by aqueous alkaline extraction at a pH from 8.0 to 12.0, or in some embodiments, to a pH from 8.5 to 9.5. While a pH greater than 10 will work for protein extraction, this pH may result in the loss of additional nutrients, for example, carotenes. Under these conditions, there was minimal degradation of other potentially valuable compounds such as β-carotene. Other retained nutrients include vitamins, carotenoids and oligosaccharides.

As will be apparent to one of skill in the art, red lentils typically have a β-carotene level around 35 μg/100 g. As such, the above-described fractions will have β-carotene levels of approximately 10-25 μg/100 g protein or approximately 15-25 μg/100 g protein or approximately 15-20 μg/100 g protein. It is of note that processing the protein under higher pH (for example, pH 12) degrades the β-carotene to a concentration of less than 5 μg/100 g. It is also important to note that there is β-carotene in other types of lentils but reported to be slightly lower levels (23 μg/100 g). As such, extracts from non-red lentils would have β-carotene levels of approximately 5-20 μg/100 g protein, approximately 5-15 μg/100 g protein, or approximately 10-15 μg/100 g protein.

As will be apparent to one of skill in the art, beta-carotene can be converted to vitamin A or can act as an antioxidant. It is further noted that studies have shown that individuals with highest levels of beta-carotene intake have lower risks of lung cancer, coronary artery heart disease, stroke and age-related eye disease than individuals with lowest levels of beta-carotene intake.

Solids are then separated from the proteins in solution using means known in the art, for example, centrifugation, although other suitable methods such as filtration may be utilized. It is of note that following this separation, the solids fraction is approximately 30-45% starch. Further washing in alkali increases the starch content. Specifically, washing removes fibre, some protein and other non-starch carbohydrates.

The protein fraction was then precipitated by acidifying the solution to a pH between 4.5 and 6.5, for example to pH 6.0, and the precipitated protein was recovered by means known in the art, for example, by centrifugation. The resulting precipitate was washed with acidified water (pH 6.0) and was then dried by freeze drying or spray drying and had a protein level of 80%. There is colour retention in the insoluble precipitated protein, indicating that the beta-carotene is retained at least in this fraction.

After acid precipitation, a soluble protein fraction remained in solution at pH 6.0. This fraction was purified by ultrafiltration through a 30,000 MWCO membrane whereby the protein was concentrated to 73% (dwb) in the retentate. The protein was readily dispersible in water and may be an effective protein supplement for use in beverages. The processing protocol developed retains other beneficial components such as β-carotene in the extracted protein, as discussed above. Other high-value components such as antioxidants and oligosaccharides are also retained in the concentrate.

As described above, at least three useful fractions are derived from the lentils: the precipitated protein, the high protein retentate and the high starch solids. With our process, we are not only considering the protein content and functionality but also extracting and maintaining functionality of other beneficial compounds present in the lentils. These will be minor, high-value components (secondary metabolites) that are typically destroyed or separated from the protein under the conditions of extraction.

Regarding uses, because the natural antioxidants are present and functional, the protein fraction could provide stability to foods that contain unsaturated fats. The fractions may be utilized in functional foods and functional food ingredients.

It is of note that the instant process applies to a lentil screening by-product that is typically disposed of or sold as a low-value feed.

Furthermore, by increasing the starch content of the screening by-product from 24% to 70% starch we have prepared a gluten-free flour/starch product for baking applications (solids fraction).

In addition to preparation of the gluten-free flour/starch, the protein component of the red lentil screening by-product has been purified to a water-soluble protein concentrate with a protein concentration greater than 70% (w/w) and insoluble protein concentrate with a protein concentration of at least 60% (w/w).

For example, the flour/starch fraction comprises a gluten-free flour for use in baking applications (e.g. bread, cookies, cakes, etc.). Other potential applications may be: in pasta (gluten-free), as a binding agent in feed formulations or as a binding agent in non-food/feed applications.

The soluble protein concentrate (the ultrafiltration retentate, >70% protein) may be used as a beverage protein supplement for example, for non-dairy beverages, diet beverages, sports beverages and the like.

The precipitated (insoluble) protein concentrate (60-80% protein or greater) may be used as protein supplements for feed and/or food ingredients uses, as meat extenders or in baked goods, snack foods or textured vegetable proteins for food or feed products. As discussed above, this fraction contains the beta carotene.

While the preferred embodiments of the invention have been described above, it will be recognized and understood that various modifications may be made therein, and the appended claims are intended to cover all such modifications which may fall within the spirit and scope of the invention.

1. A method comprising:
providing a hull-reduced lentil fraction;
solubilizing the protein in the hull-reduced lentil fraction by subjecting the hull-reduced lentil fraction to an aqueous alkaline extraction, thereby providing a protein enriched fraction;
removing solids from the protein enriched fraction, thereby providing a solids fraction having a high starch content and a solubilized protein enriched fraction;
precipitating the protein from the solubilized protein enriched fraction by acidifying the solubilized protein enriched fraction, thereby producing precipitated protein and a retentate; and
recovering the precipitated protein.

2. The method of claim 1 wherein the alkaline extraction is at a pH of 8.5 to 9.5.

3. The method of claim 1 wherein the solubilized protein enriched fraction is acidified to a pH between 4.5 and 6.5.
